(19) United States
(12) Patent Application Publication
(10) Pub. No.: US 2025/0183956 A1
(43) Pub. Date: Jun. 5, 2025

(54) DIGITAL POST DISTORTION WITH TRANSMIT ANTENNA SELECTION

(71) Applicant: QUALCOMM Incorporated, San Diego, CA (US)

(72) Inventors: Amit MOSES, Tel Aviv (IL); Ronen SHAKED, Kfar Saba (IL); Aviv REGEV, Tel Aviv (IL)

(21) Appl. No.: 18/529,729

(22) Filed: Dec. 5, 2023

(51) Int. Cl. H04B 7/06; H04B 1/04

(52) U.S. Cl. CPC H04B 7/0608; H04B 1/0475; H04B 2001/0408

(57) ABSTRACT

Certain aspects of the present disclosure provide techniques for digital post distortion (DPD) with antenna selection. A method for wireless communication by a user equipment (UE) includes receiving signaling from a network entity indicating one or more selected transmit antennas. The method includes receiving a data transmission from the network entity and performing DPOD processing of the data transmission based on the one or more selected transmit antennas.

### FIELD OF THE DISCLOSURE

Aspects of the present disclosure relate to wireless communications, and more particularly, to techniques for digital post distortion (DPOD).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving signaling from a network entity indicating one or more selected transmit antennas. The method includes receiving a data transmission from the network entity. The method includes performing DPOD processing of the data transmission based on the one or more selected transmit antennas.

Another aspect provides a method for wireless communication by a network entity. The method includes obtaining signaling from a UE of a capability of the UE for performing DPOD based on antenna selection. The method includes outputting signaling to the UE indicating one or more selected transmit antennas of the network entity. The method includes outputting a data transmission to the UE using the one or more selected transmit antennas.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a block diagram conceptually illustrating an example transmit chain with digital pre-distortion (DPD).

FIG. 6 depicts an example receive chain with DPOD.

FIG. 7 depicts example antenna selection.

FIG. 8 depicts example antenna on/off switching.

FIG. 9 depicts an example call flow for DPOD with antenna selection.

FIG. 10 depicts example DPOD processing.

FIG. 11 depicts an example method for wireless communications by a UE.

FIG. 12 depicts an example method for wireless communications by a network entity.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for DPOD with antenna selection.

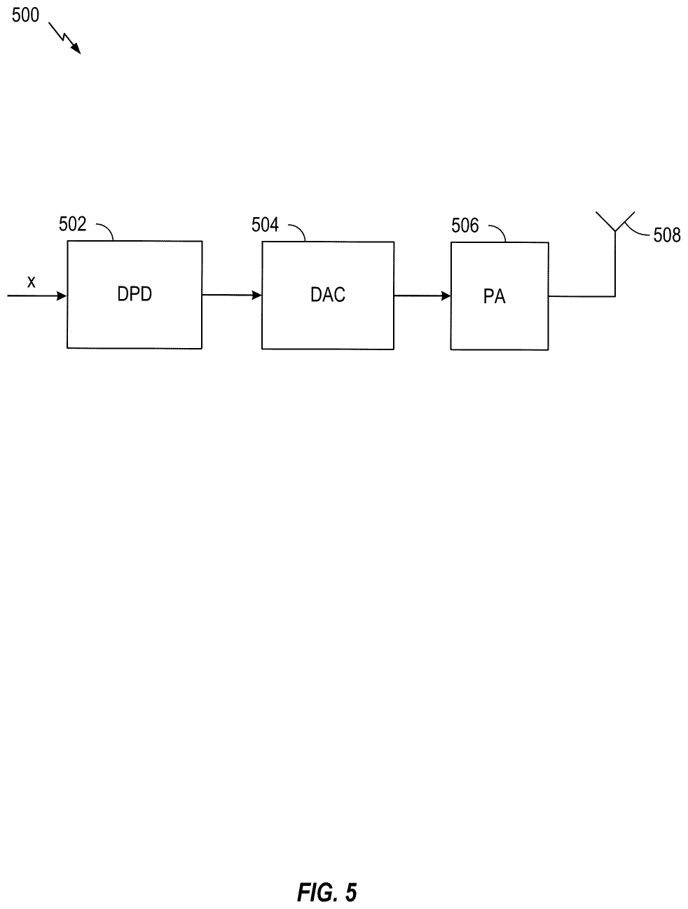

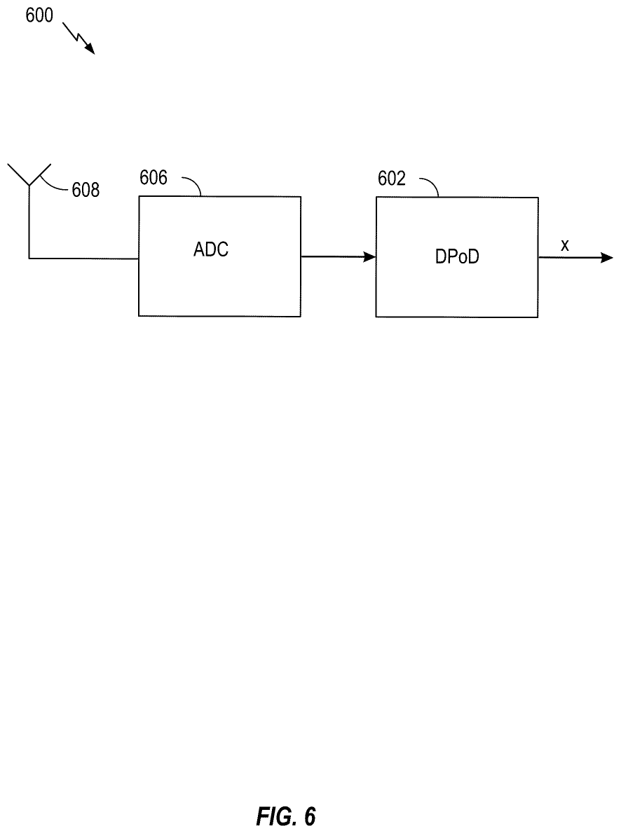

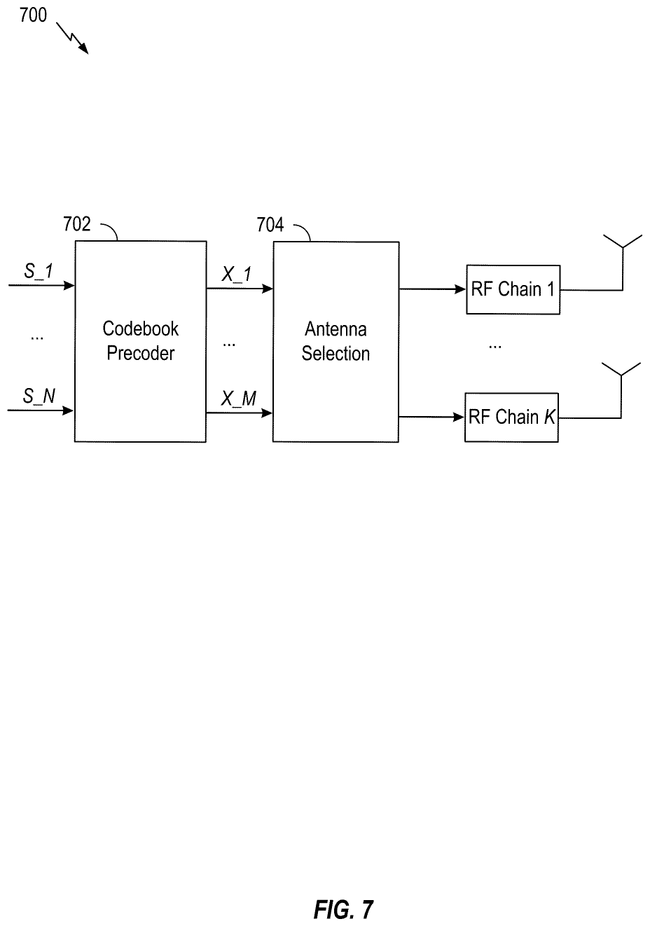

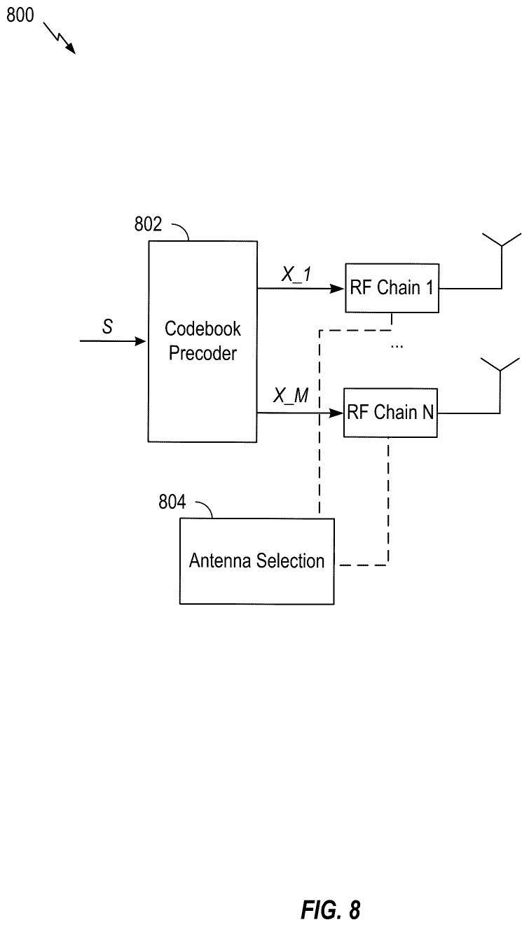

As discussed in more detail herein with respect to FIGS. 5-6, DPOD processing can be performed by a device that receives a signal to remove estimated nonlinear distortion in the signal due to a power amplifier transfer function at the transmitter of signal. As discussed in more detail herein with respect to FIGS. 7-8, the complexity, overhead, power consumption, and latency of DPOD increases with the number of transmit antennas at the transmitter side. As wireless communications employ devices using larger number of antennas, such as base stations (BS) using massive MIMO in 5G NR and 6G NR systems, the reduce the complexity, overhead, power consumption, and latency of DPOD at the receiver (e.g., a UE) increases.

Accordingly, techniques are desired for improved DPOD that reduces these complexity, overhead, power consumption, and latency issues.

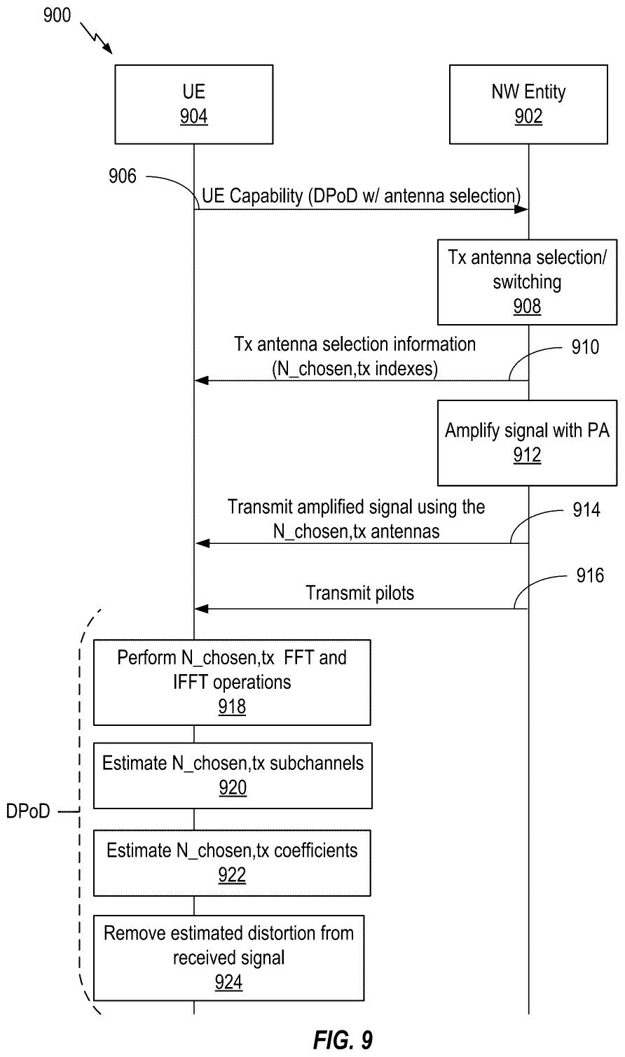

Some systems use techniques to reduce the number of transmit antennas, such as antenna selection and/or antennas on/off switching. As discussed in more detail herein with respect to FIGS. 9-14, aspects of the present disclosure provide apparatuses, methods, processing systems, and computer-readable mediums that allow the receiving device to leverage knowledge of the transmit antennas selected at the transmitter device in DPOD processing to alleviate the problems discussed above.

In some aspects, the receiving device signals a capability of the receiving device for performing DPOD with transmit antenna selection. In some aspects, the transmitter device signals an indication of the selected transmit antennas to the receiving device. In some aspects, the transmitter sends a transmission to the receiving device using only the selected transmit antennas and the receiving device performs DPOD processing based on the selected subset of transmit antennas. In some aspects, in iteratively estimating the nonlinear distortion to remove from the received signal, the receiving device estimates only the subchannels associated with the selected subset of transmit antennas, performs kernel projection only for the selected subset of transmit antennas, and estimates coefficients of a power amplifier model only for the selected subset of transmit antennas. Accordingly, the complexity, overhead, power consumption, and latency of the DPOD is reduced in each iteration of the DPOD processing.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

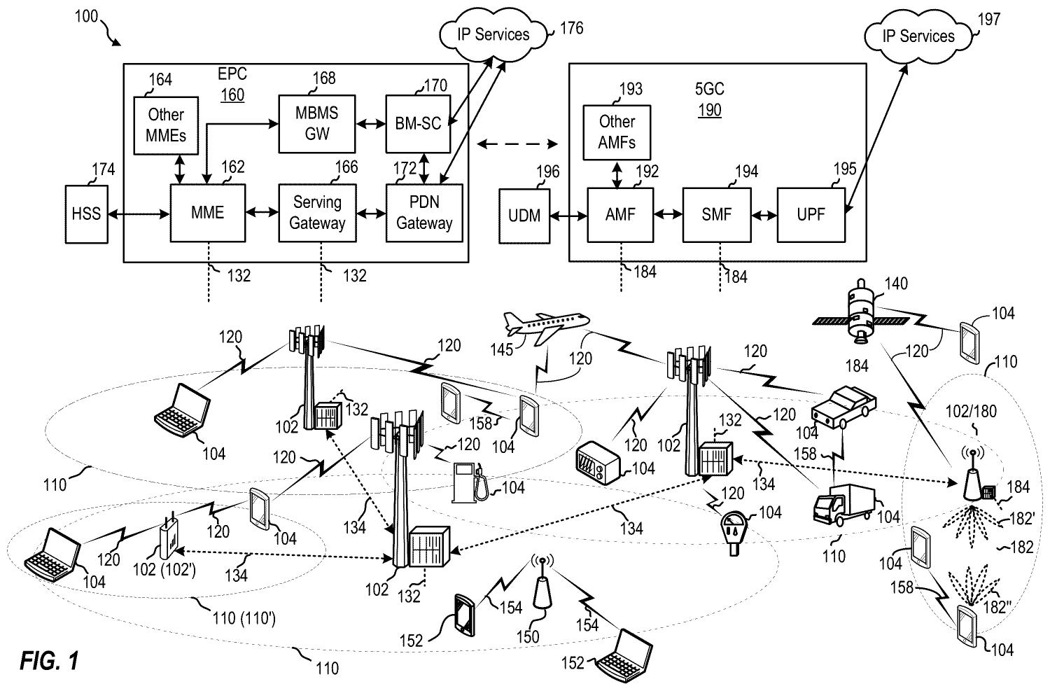

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

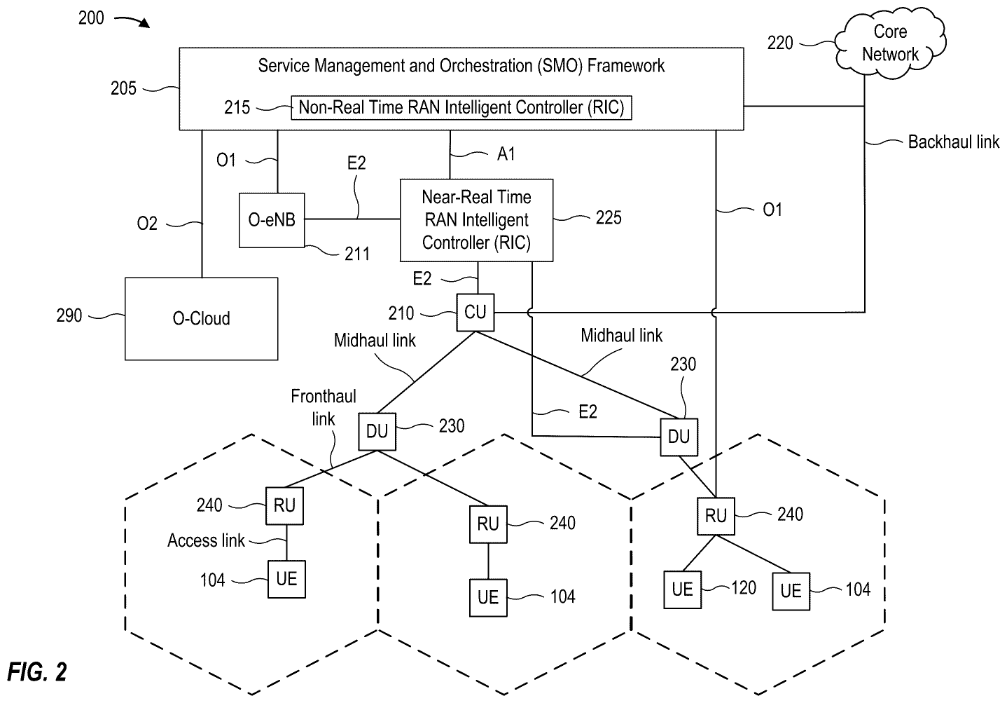

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

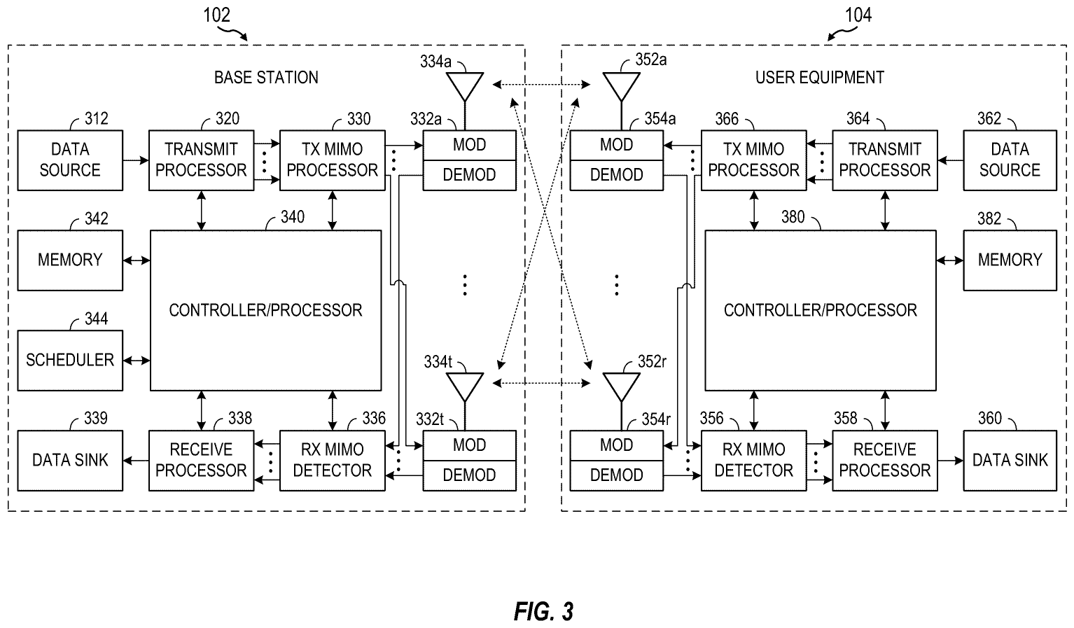

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

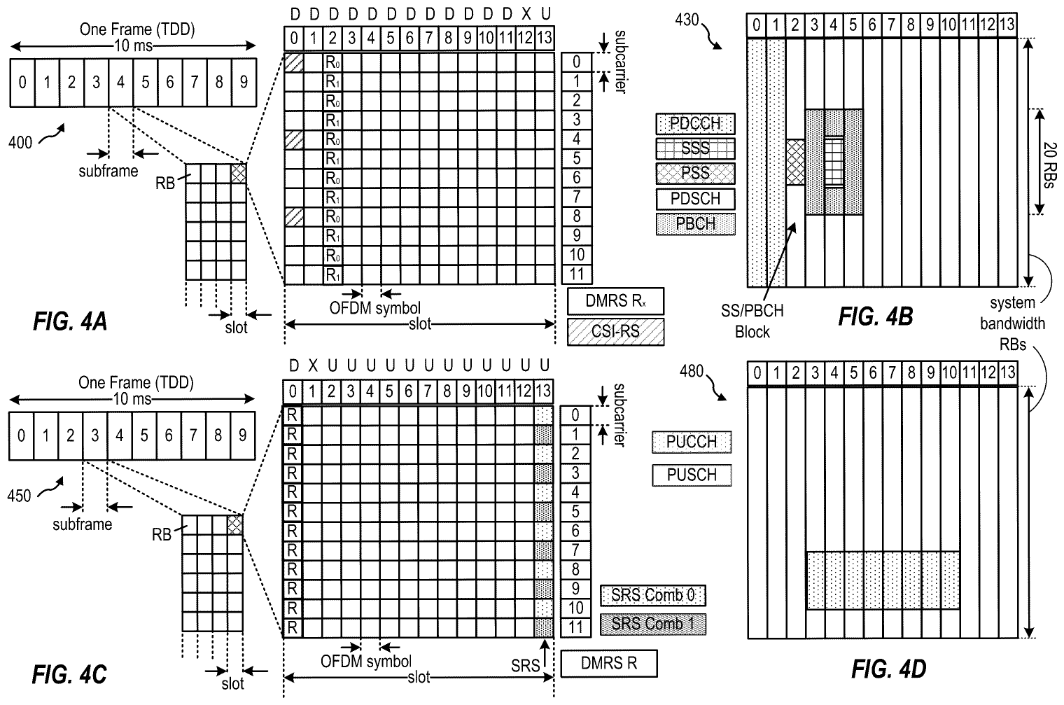

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or CSI-RS for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to DPOD with Antenna Selection

Aspects of the present disclosure provide apparatuses, methods, processing systems, and computer-readable mediums for mitigating distortion caused by a power amplifier (PA) to a signal that is input to the PA. A PA is a device that increases (amplifies) the power of a signal input to the PA.

Some wireless communication networks, such as 5G NR based networks, use an orthogonal frequency-division multiple access (OFDMA) digital modulation scheme. OFDMA offers multiple access by assigning subsets of subcarriers (corresponding to frequency resources) in each symbol (corresponding to a time resource) to different uplink transmissions, downlink transmissions, or both uplink and downlink transmissions, making efficient use of radio resources. OFDMA also provides simple channel estimation at a device receiving an OFDMA signal and flexibility in the utilization of time and frequency resources. However, OFDMA may result in a higher peak-to-average power ratio (PAPR).

A high power PA may be used to amplify the signal for transmission by a communications device (e.g., UE 104, a network entity 102, etc.).

To reduce power consumption, which may be desirable for example to support green network, the PA can be operated at a lower power level with power back-off. However, the back-off reduces the efficiency of the PA and may add non-linearity corrupting error to the transmitted signal, for example, due to the PA transfer function (e.g., AM/AM and AM/PM distortions).

Ideally, all amplifiers should be perfectly linear, which means the output signal should be an (amplified) exact copy of the input signal. However, PAs are not perfectly linear because amplifying devices, such as transistors or vacuum tubes, are non-linear by nature which introduces some amount of non-linearity in the output (e.g., the amplified signal) of the PA. Non-linearity generates spectral re-growth, which leads to interference and can lead to violation of emissions standards set by regulatory bodies. Non-linearity can also lead to the degradation of the bit-error rate (BER) and data throughput of the communication system.

Non-linear distortion may be in-band and/or out-of-band. In-band distortion causes degradation of the EVM. EVM is a measure of the performance of a transmitter. A signal sent by an ideal transmitter would have all constellation points at the ideal locations, however distortion causes the actual constellation points to deviate from the ideal locations. Out-of-band distortion causes adjacent channel leakage ratio (ACLR) to increase and may result in interference. ACLR is the ratio of the transmitted power on the assigned channel by the transmitting device to the power received in the adjacent radio channel measured at a receiving device.

DPD and DPOD techniques allow PAs to be used near the saturation power of the PA to maximize efficiency and performance, while reducing distortion in the signal to avoid degradation of EVM and to avoid increase in the out-of-band emissions (measured, e.g., by the ACLR metric). Saturated output power is the maximum output power of the PA.

DPD is a technique where inverse distortion is applied, using a pre-distorter, to the input signal of the PA to cancel the distortion generated by the PA, at a transmitting device. To apply the correct inverse distortion, the characteristics of the PA should be accurately known and modeled. FIG. 5 is a block diagram conceptually illustrating an example transmit chain 500 having DPD circuitry 502. Generally, a communications device (e.g., a BS 102 or a UE 104 illustrated in FIG. 1) generates a signal, x, to transmit using a transmit chain 500. The signal starts in the digital domain before being converted to the analog domain by a digital-to-analog converter (DAC) 504 and being sent to a PA 506. The PA 506 amplifies the analog signal before providing the amplified signal to the antenna 508 for transmission to a receiving device.

Techniques by a receiving device for mitigating the impact of distortion are referred to as DPOD. FIG. 6 depicts an example receive chain 600 with DPOD circuitry 602. The receiving device may receive the signal from a transmitting device with the antenna 608. DPOD may be applied to the received signal with the DPOD circuitry 602 after an analog-to-digital converter (ADC) 606 converts the signal from the analog domain to the digital domain.

DPOD mitigates non-linearity in the received signal (e.g., a data transmission on a PDSCH) by applying a correction to the received signal to adjust for estimated non-linearity added by the transmitter's PA. A DPOD process may include iteratively estimating a coefficient model of the transmitter's PA. The estimation of the PA model may be assisted by pilots, such as DMRS pilots. The distortion in the received signal may be estimated by applying the estimated PA model on hard decisions on the received signal. The receiving device uses a codebook precoder to reconstruct the signal in the transmit domain. The codebook precoder may be updated (e.g., every CSI-RS). The estimated distortion can then be subtracted from the received signal.

As number of transmit antennas at the transmitter-side increases, more PA coefficients are estimated for the DPOD, and the complexity and overhead for the DPOD increases, resulting in higher power consumption at the receiver side and additional latency. In addition, there is a demand for more pilots resulting in loss of bandwidth available for data transmission. The power consumption issue may be exacerbated as the associated bandwidth increases (e.g., in sub-THz operation in which the bandwidth may be 10 GHz).

Accordingly, there is a need to reduce DPOD complexity, overhead, and latency at the receiver. According to certain aspects, the DPOD can be performed with knowledge of antenna selection as the transmitter-side to reduce the complexity, overhead, and latency at the receiver.

In order to improve both cost and power efficiency, for example in power hungry MIMO systems using a large number of RF chains, analog signal processing can be employed to reduce signal dimension within the RF-analog domain to effectively reduce the number of RF transceivers. Two approaches to achieve this are by applying antenna selection algorithms, as shown in FIG. 7, or by selectively deactivating (e.g., switching off) certain subsets of transmit antennas as shown in FIG. 8.

As shown in FIG. 7, an example antenna selection scheme 700 inputs N signal streams (S₁, . . . , S_{N}) to codebook precoder block 702 which outputs M precoded signal streams (X₁, . . . , X_{M}) to the antenna selection block 704. The antenna selection block 704 selects K antennas (or RF chains), to use for transmitting the precoded signal streams (e.g., based on an antenna selection algorithm). As shown in FIG. 8, an example antenna on/off switching scheme 800 inputs the signal S to the codebook precoder block 802 which outputs M precoded signal streams (X₁, . . . , X_{M}). An antenna selection block 804 may switch on N antennas (or RF chains) to use for transmitting the precoded signal streams. The number of selected antennas N may be equal to the number precoded signal streams M.

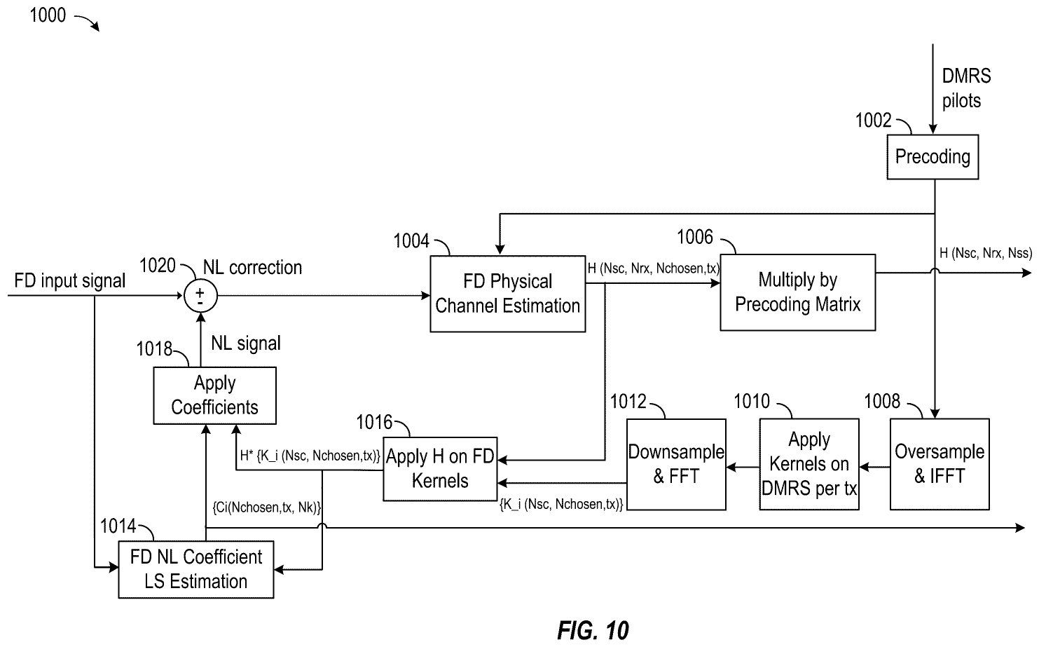

According to certain aspects, if the receiver device has knowledge of the selected transmit antennas, or RF chains, the receiver device can use the information in the DPOD algorithm to reduce the complexity, overhead, and latency of the DPOD. For example, as discussed in more detail herein with respect to FIG. 10, the receiver can use the information of the selected transmit antennas to reduce the complexity of the DPOD algorithm by reducing the number of fast Fourier transform (FFT) and inverse FFT (IFFT) operations, by reducing the number of estimated PA coefficients, and by reducing the number of sub-channels estimated and applied in the DPOD algorithm, based the number of selected transmit antennas.

According to certain aspects, the transmit device signals the receiver device an indication of the selected transmit antennas (or transmit chains). In some aspects, the transmit device uses a codebook precoder with a higher dimension than the number of selected antennas (or RF chains). In some aspects, the transmit device signals the receiver device an indication of the specific transmit antennas that selected.

According to certain aspects, the receiver device (e.g., a UE) provide capability information to the transmitting device (e.g., a network entity, such as a BS) indicating that the receiver device is capable of reduced DPOD based on the transmit antenna selection. The transmit device may provide the indication of the selected transmit antennas in response to the capability of the receiver device.

FIG. 9 depicts a process flow 900 for communications in a network between a network entity 902 and a UE 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device and network entity 902 may be another type of network entity or network node, such as those described herein.

Optionally, at operation 906, UE 904 may signal capability information to the network entity 902. In some aspects, the capability information indicates a capability of the UE 904 to perform DPOD with transmit antenna selection (or switching). In some aspects, the UE 904 signals the capability information to the network entity 902 in a PUCCH. In some aspects, the UE 904 signals the capability information to the network entity 902 in an RRC message, a PUSCH, or other type of signaling.

At operation 908, the network entity 902 selects one or more transmit antennas (or transmit chains) to use for a transmission to the UE 904. In some aspects, the network entity 902 performs an antenna selection algorithm to select the one or more transmit antennas. In some aspects, the network entity 902 performs an antenna switching on/off algorithm to select the one or more transmit antennas. In some aspects, the network entity 902 selects a subset of transmit antennas, N_{chosen,tx}, of its total available transmit antennas Nₜₓ.

At operation 910, the network entity 902 signals transmit antenna selection information to the UE 904. In some aspects, the transmit antenna selection information indicates the specific selected transmit antennas. For example, the network entity 902 may signal an index of the selected transmit antennas to the UE 904. In some aspects, the network entity 902 signals a bitmap indicating the selected transmit antennas. The bitwidth of the bitmap may be equal to the number of total available transmit antennas, Nₜₓ, with each bit mapped to a transmit antennas index and indicating whether the associated transmit antennas is selected (e.g., used/unused, on/off). In some aspects, the network entity 902 provides the transmit antenna selection to the UE 904 with a different indication than the index or bitmap. In some aspects, the network entity 902 signals transmit antenna selection information to the UE 904 in dynamic signaling. For example, the network entity 902 may signal the transmit antenna selection information to the UE 904 in a PDCCH, a PDSCH, a MAC CE, or other signaling.

The network entity 902 then sends the transmission (e.g., data on a PDSCH) to the UE 904 using the selected one or more transmit antennas. For example, at operation 912, the network entity 902 may amplify the signal to be transmitted using the PAs in the transmit chains for the selected antennas and, at operation 914, the network entity 902 transmits the amplified signal to the UE 904 using the selected one or more transmit antennas.

In some aspects, the network entity 902 periodically performs the antenna selection (or switching) and sends the transmit antenna selection to the UE 904. For example, each time physical channel estimation is performed, the network entity 902 may perform the antenna selection and send the transmit antenna selection information to the UE 904.

At operations 918-924, after receiving the transmission from the network entity 902, transmitted at operation 914, the UE 904 performs DPOD to remove estimated distortion added to the signal by the PA(s) of the network entity 902. The UE 904 performs the DPOD based on the specific transmit antennas used for the transmission based on the transmit antenna selection information provided at operation 910.

In some aspects, the DPOD involves estimating the PA (of the network entity 902) model and using the model to correct the received signal and mitigate the nonlinear noise in the received signal. The UE 904 received the signal in the rx (receive) domain and may use a codebook precoder to reconstruct the distortion in the tx domain. To estimate the model, the UE 904 estimated the coefficients of non-linearity kernels to model the PA transfer function. In some aspects, the UE 904 applies kernel projection only the selected (subset) of the transmit antennas, N_{chosen,tx}.

At operation 916, the network entity 902 may transmit pilots to the UE 904 for channel estimation.

As shown, at operation 918, the UE 904 performs FFT and IFFT only for the selected N_{chosen,tx}. For example, in some systems, for DPOD, the receiving device uses the precoder in order to transform from the layer domain to the tx domain, and each tx domain signal passes through a processing chain containing an IFFT block (e.g., and oversampling), a kernel projection processing block (kernel projection), and an FFT block (e.g., and downsampling). The number of the IFFT, kernel projection, and FFT blocks is based on the number of transmit antennas. Without knowledge of the selected transmit antennas, the IFFT, kernel projection, and FFT blocks are performed for the total available transmit antennas, Nₜₓ. Without knowledge of the selected transmit antennas, the processing chains (e.g., the IFFT, kernel projection, and FFT blocks) are reduced to only those needed for the N_{chosen,tx} transmit antennas. For example, the total number of IFFT and FFT operations may be reduced from 2Nₜₓ to 2N_{chosen,tx} (the unused processing chains may be disabled).

At operation 920, the UE 904 may estimate the subchannels associated with the N_{chosen,tx} transmit antennas. The channel between the UE 904 and the network entity 902 may corresponds to the subchannels between each of the receive antennas (Nᵣₓ) of the UE 904 and the transmit antennas of the network entity 902 represented by an Nᵣₓ×Nₜₓ matrix. Because only a subset of transmit antennas are used, the physical channel effectively has a lower dimension and the UE 904 does not need to estimate the subchannels associated with the unused transmit antennas corresponding to a reduced Nᵣₓ×N_{chosen,tx} matrix. In some aspects, the estimated subchannels are applied to the nonlinearity kernels.

At operation 922, the UE 904 may estimate N_{chosen,tx} nonlinear coefficients. In some aspects, the UE 904 estimates the nonlinear coefficients only for the PA(s) corresponding to the N_{chosen,tx} selected subset of transmit antennas (or transmit chains). Thus, the number estimated parameters may be reduced from (Nₜₓ·#kernels) to (N_{chosen,tx}·#kernels). In some aspects, the PA coefficient estimation uses the kernel projection of the tx domain signal.

At operation 924, the UE 904 removes the estimated distortion from the received signal.

FIG. 10 depicts example DPOD processing blocks 1000. As shown in FIG. 10, the received frequency domain (FD) input signal may iteratively corrected by subtracting an estimated nonlinearity signal at NL correction block 1020. The FD input signal and/or a processed signal are used at FD NL coefficient least squares estimation block 1014 to model the transmitter PA. The FD input signal (initially) or corrected signal (in iterations) is used for channel estimation at FD physical channel estimation block 1004. The channel estimation uses DMRS pilots precoded at precoding block 1002. The estimated channel H is based on the number of subcarriers N_{sc}, Nᵣₓ, and N_{chosen,tx}. The estimated channel, H, is applied to the FD kernels at block 1016. The estimated channel, H, is multiplied by the precoding matrix at the block 1006, providing the estimated channel based on the N_{sc}, Nᵣₓ, and the number of spatial streams Nₛₛ.

The precoded DMRS pilots may be processed at oversample and IFFT block 1008, kernel application block 1010, and downsample and FFT block 1012. The blocks 1008-1012 are reduced by performing the blocks only for the selected N_{chosen,tx} transmit antennas. The number of the FD NL kernels, Kᵢ, are based on N_{sc} and N_{chosen,tx}.

The estimated channel H is applied to the FD kernels Kᵢ at block 1016. The effective dimension of the channel H is reduced to the only subchannels associated with the selected N_{chosen,tx} transmit antennas.

At the FD NL coefficient least squares (LS) estimation block 1014, the coefficients Cᵢ are estimated for the received signal, x, on the kernels after applying the channel (H*Kᵢ). The number of coefficients is based on the selected N_{chosen,tx} transmit antennas and the number of kernels, Nₖ.

In some aspects, a kernel may be given by the coefficients and kernel projection on the received signal as:

$$f ( x ) = {c}_{0} x + {c}_{1} x {\vert x \vert}^{2} + {c}_{2} x {\vert x \vert}^{4}$$

For x(t) samples, this gives:

$$f ( x ( t ) ) = {c}_{0} x ( t ) + {c}_{1} x ( t ) {\vert x ( t ) \vert}^{2} + {c}_{2} x ( t ) {\vert x ( t ) \vert}^{4} + noise ( t ) ; and$$

The least squares estimation may be given by \hat{θ}=(M^{H} M)⁻¹ M^{H} f (x(t)).

In each iteration of the DPOD algorithm, the value of x may change as the nonlinearity is reduced with each iteration providing a cleaner signal.

At block 1018 the estimated coefficients are kernels are applied to generate the nonlinearity signal used in the NL correction block 1020.

### Example Operations

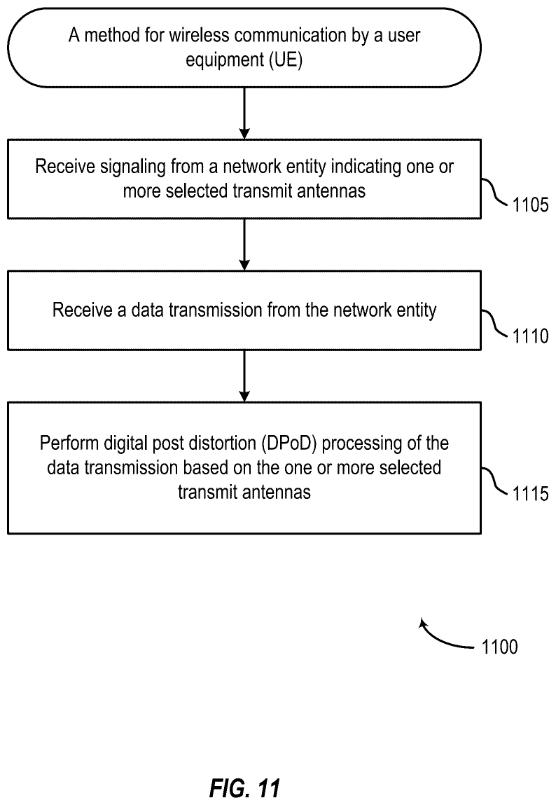

FIG. 11 shows an example of a method 1100 of wireless communication by a user equipment (UE), such as a UE 104 of FIGS. 1 and 3.

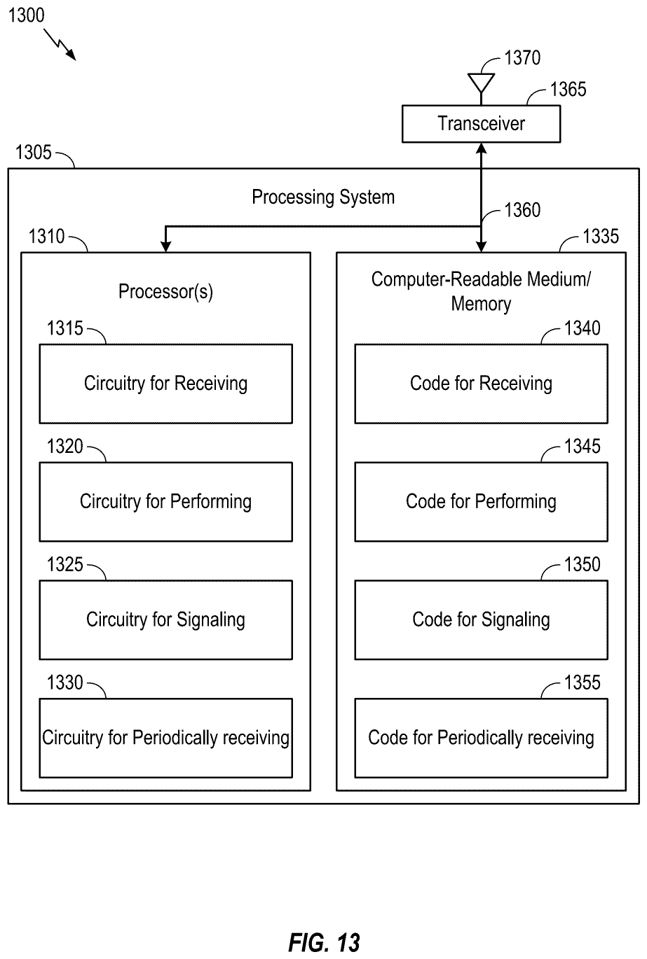

Method 1100 begins at step 1105 with receiving signaling from a network entity indicating one or more selected transmit antennas. In some cases, the operations of this step refer to, or may be performed by, circuitry for receiving and/or code for receiving as described with reference to FIG. 13.

Method 1100 then proceeds to step 1110 with receiving a data transmission from the network entity. In some cases, the operations of this step refer to, or may be performed by, circuitry for receiving and/or code for receiving as described with reference to FIG. 13.

Method 1100 then proceeds to step 1115 with performing digital post distortion (DPOD) processing of the data transmission based on the one or more selected transmit antennas. In some cases, the operations of this step refer to, or may be performed by, circuitry for performing and/or code for performing as described with reference to FIG. 13.

In some aspects, the one or more selected transmit antennas comprises a subset of transmit antennas at the network entity.

In some aspects, the method 1100 further includes signaling a capability of the UE for performing DPOD based on antenna selection. In some cases, the operations of this step refer to, or may be performed by, circuitry for signaling and/or code for signaling as described with reference to FIG. 13.

In some aspects, signaling the capability of the UE for performing DPOD based on antenna selection is via a physical uplink control channel (PUCCH).

In some aspects, signaling the capability of the UE for performing DPOD based on antenna selection is via a radio resource control (RRC) message.

In some aspects, the signaling from the network entity indicating the one or more selected transmit antennas comprises dynamic signaling of the one or more selected transmit antennas.

In some aspects, the dynamic signaling of the one or more selected transmit antennas is via a physical downlink control channel (PDCCH).

In some aspects, the signaling from the network entity indicating the one or more selected transmit antennas comprises one or more indexes of the one or more selected transmit antennas.

In some aspects, the signaling from the network entity indicating the one or more selected transmit antennas comprises a bitmap indicating the one or more selected antennas.

In some aspects, the method 1100 further includes periodically receiving signaling from the network entity indicating one or more selected transmit antennas. In some cases, the operations of this step refer to, or may be performed by, circuitry for periodically receiving and/or code for periodically receiving as described with reference to FIG. 13.

In some aspects, performing DPOD processing of the data transmission based on the one or more selected transmit antennas comprises: estimating distortion added to the data transmission; and removing the estimated distortion from the received data transmission.

In some aspects, estimating the distortion added to the data transmission comprises: decoding one or more demodulation reference signals (DMRS); and determining precoding based on the one or more DMRS.

In some aspects, estimating the distortion added to the data transmission comprises performing Fast Fourier transform (FFT) and inverse FFT (IFFT) processing to generate a set of non-linearity kernels associated with the data transmission, wherein a number of FFT operations and a number of IFFT operations is based on a number of the selected one or more transmit antennas.

In some aspects, estimating the distortion added to the data transmission comprises: estimating a channel between the UE and the network entity; and applying only subchannels, of the channel, associated with the selected one or more transmit antennas to the set of non-linearity kernels.

In some aspects, the subchannels comprises the subchannels between each receive antenna at the UE and each of the selected one or more transmit antennas of the network entity.

In some aspects, estimating the distortion added to the data transmission comprises estimating non-linearity coefficients of a power amplifier (PA) model of a PA at the transmitter of the data transmission, wherein a number of the non-linearity coefficients is based on a number of the selected one or more transmit antennas and a number of the set of non-linearity kernels.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

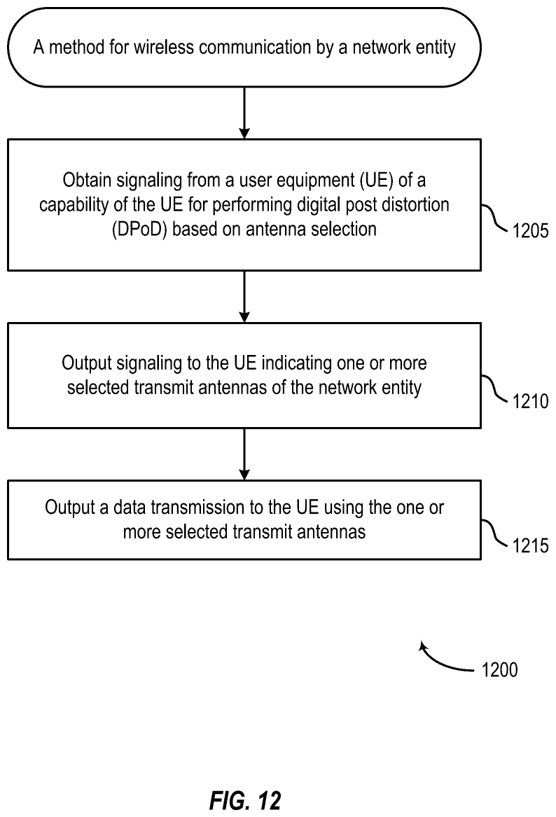

FIG. 12 shows an example of a method 1200 of wireless communication by a network entity, such as a BS 102 of FIGS. 1 and 3, or a disaggregated base station as discussed with respect to FIG. 2.

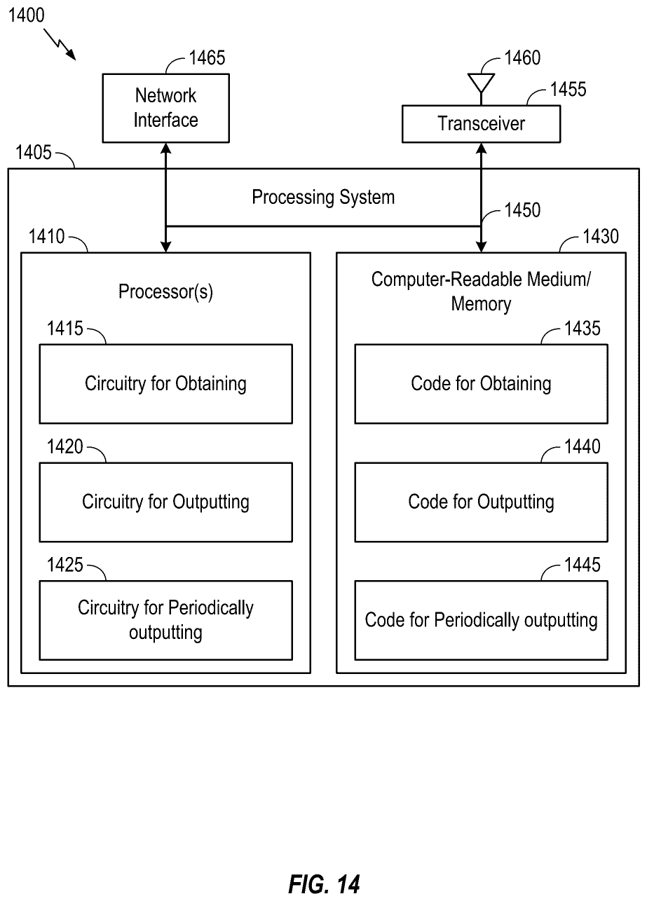

Method 1200 begins at step 1205 with obtaining signaling from a user equipment (UE) of a capability of the UE for performing digital post distortion (DPOD) based on antenna selection. In some cases, the operations of this step refer to, or may be performed by, circuitry for obtaining and/or code for obtaining as described with reference to FIG. 14.

Method 1200 then proceeds to step 1210 with outputting signaling to the UE indicating one or more selected transmit antennas of the network entity. In some cases, the operations of this step refer to, or may be performed by, circuitry for outputting and/or code for outputting as described with reference to FIG. 14.

Method 1200 then proceeds to step 1215 with outputting a data transmission to the UE using the one or more selected transmit antennas. In some cases, the operations of this step refer to, or may be performed by, circuitry for outputting and/or code for outputting as described with reference to FIG. 14.

In some aspects, the one or more selected transmit antennas comprises a subset of transmit antennas at the network entity.

In some aspects, obtaining the signaling from the UE of the capability of the UE for performing DPOD based on antenna selection is via a physical uplink control channel (PUCCH).

In some aspects, obtaining the signaling from the UE of the capability of the UE for performing DPOD based on antenna selection is via a radio resource control (RRC) message.

In some aspects, the signaling to the UE indicating the one or more selected transmit antennas comprises dynamic signaling of the one or more selected transmit antennas.

In some aspects, the dynamic signaling of the one or more selected transmit antennas is via a physical downlink control channel (PDCCH).

In some aspects, the signaling to the UE indicating the one or more selected transmit antennas comprises one or more indexes of the one or more selected transmit antennas.

In some aspects, the signaling to the UE indicating the one or more selected transmit antennas comprises a bitmap indicating the one or more selected antennas.

In some aspects, the method 1200 further includes periodically outputting signaling to the UE indicating one or more selected transmit antennas. In some cases, the operations of this step refer to, or may be performed by, circuitry for periodically outputting and/or code for periodically outputting as described with reference to FIG. 14.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Communications Device(s)

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to the transceiver 1365 (e.g., a transmitter and/or a receiver). The transceiver 1365 is configured to transmit and receive signals for the communications device 1300 via the antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1335 stores code (e.g., executable instructions), such as code for receiving 1340, code for performing 1345, code for signaling 1350, and code for periodically receiving 1355. Processing of the code for receiving 1340, code for performing 1345, code for signaling 1350, and code for periodically receiving 1355 may cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry such as circuitry for receiving 1315, circuitry for performing 1320, circuitry for signaling 1325, and circuitry for periodically receiving 1330. Processing with circuitry for receiving 1315, circuitry for performing 1320, circuitry for signaling 1325, and circuitry for periodically receiving 1330 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1365 and the antenna 1370 of the communications device 1300 in FIG. 13. Means for receiving or obtaining may include transceivers 354 and/or antenna(s) 352 of the UE 104 illustrated in FIG. 3 and/or the transceiver 1365 and the antenna 1370 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1455 (e.g., a transmitter and/or a receiver) and/or a network interface 1465. The transceiver 1455 is configured to transmit and receive signals for the communications device 1400 via the antenna 1460, such as the various signals as described herein. The network interface 1465 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, cause the one or more processors 1410 to perform the method 1200 described with respect to FIG. 12, or any aspect related to it. Note that reference to a processor of communications device 1400 performing a function may include one or more processors 1410 of communications device 1400 performing that function.

In the depicted example, the computer-readable medium/memory 1430 stores code (e.g., executable instructions), such as code for obtaining 1435, code for outputting 1440, and code for periodically outputting 1445. Processing of the code for obtaining 1435, code for outputting 1440, and code for periodically outputting 1445 may cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry such as circuitry for obtaining 1415, circuitry for outputting 1420, and circuitry for periodically outputting 1425. Processing with circuitry for obtaining 1415, circuitry for outputting 1420, and circuitry for periodically outputting 1425 may cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1455 and the antenna 1460 of the communications device 1400 in FIG. 14. Means for receiving or obtaining may include transceivers 332 and/or antenna(s) 334 of the BS 102 illustrated in FIG. 3 and/or the transceiver 1455 and the antenna 1460 of the communications device 1400 in FIG. 14.

### Example Clauses

Implementation examples are described in the following numbered clauses:

Clause 1: A method for wireless communication by a user equipment (UE), comprising: receiving signaling from a network entity indicating one or more selected transmit antennas; receiving a data transmission from the network entity; and performing digital post distortion (DPOD) processing of the data transmission based on the one or more selected transmit antennas.

Clause 2: The method of Clause 1, wherein the one or more selected transmit antennas comprises a subset of transmit antennas at the network entity.

Clause 3: The method of any one of Clauses 1-2, further comprising signaling a capability of the UE for performing DPOD based on antenna selection.

Clause 4: The method of Clause 3, wherein signaling the capability of the UE for performing DPOD based on antenna selection is via a physical uplink control channel (PUCCH).

Clause 5: The method of Clause 3, wherein signaling the capability of the UE for performing DPOD based on antenna selection is via a radio resource control (RRC) message.

Clause 6: The method of any one of Clauses 1-5, wherein the signaling from the network entity indicating the one or more selected transmit antennas comprises dynamic signaling of the one or more selected transmit antennas.

Clause 7: The method of Clause 6, wherein the dynamic signaling of the one or more selected transmit antennas is via a physical downlink control channel (PDCCH).

Clause 8: The method of any one of Clauses 1-7, wherein the signaling from the network entity indicating the one or more selected transmit antennas comprises one or more indexes of the one or more selected transmit antennas.

Clause 9: The method of any one of Clauses 1-8, wherein the signaling from the network entity indicating the one or more selected transmit antennas comprises a bitmap indicating the one or more selected antennas.

Clause 10: The method of any one of Clauses 1-9, further comprising periodically receiving signaling from the network entity indicating one or more selected transmit antennas.

Clause 11: The method of any one of Clauses 1-10, wherein performing DPOD processing of the data transmission based on the one or more selected transmit antennas comprises: estimating distortion added to the data transmission; and removing the estimated distortion from the received data transmission.

Clause 12: The method of Clause 11, wherein estimating the distortion added to the data transmission comprises: decoding one or more demodulation reference signals (DMRS); and determining precoding based on the one or more DMRS.

Clause 13: The method of Clause 11, wherein estimating the distortion added to the data transmission comprises performing Fast Fourier transform (FFT) and inverse FFT (IFFT) processing to generate a set of non-linearity kernels associated with the data transmission, wherein a number of FFT operations and a number of IFFT operations is based on a number of the selected one or more transmit antennas.

Clause 14: The method of Clause 13, wherein estimating the distortion added to the data transmission comprises: estimating a channel between the UE and the network entity; and applying only subchannels, of the channel, associated with the selected one or more transmit antennas to the set of non-linearity kernels.

Clause 15: The method of Clause 14, wherein the subchannels comprises the subchannels between each receive antenna at the UE and each of the selected one or more transmit antennas of the network entity.

Clause 16: The method of Clause 14, wherein estimating the distortion added to the data transmission comprises estimating non-linearity coefficients of a power amplifier (PA) model of a PA at the transmitter of the data transmission, wherein a number of the non-linearity coefficients is based on a number of the selected one or more transmit antennas and a number of the set of non-linearity kernels.

Clause 17: A method for wireless communication by a network entity, comprising: obtaining signaling from a user equipment (UE) of a capability of the UE for performing digital post distortion (DPOD) based on antenna selection; outputting signaling to the UE indicating one or more selected transmit antennas of the network entity; and outputting a data transmission to the UE using the one or more selected transmit antennas.

Clause 18: The method of Clause 17, wherein the one or more selected transmit antennas comprises a subset of transmit antennas at the network entity.

Clause 19: The method of any one of Clauses 17-18, wherein obtaining the signaling from the UE of the capability of the UE for performing DPOD based on antenna selection is via a physical uplink control channel (PUCCH).

Clause 20: The method of any one of Clauses 17-19, wherein obtaining the signaling from the UE of the capability of the UE for performing DPOD based on antenna selection is via a radio resource control (RRC) message.

Clause 21: The method of any one of Clauses 17-20, wherein the signaling to the UE indicating the one or more selected transmit antennas comprises dynamic signaling of the one or more selected transmit antennas.

Clause 22: The method of Clause 21, wherein the dynamic signaling of the one or more selected transmit antennas is via a physical downlink control channel (PDCCH).

Clause 23: The method of any one of Clauses 17-22, wherein the signaling to the UE indicating the one or more selected transmit antennas comprises one or more indexes of the one or more selected transmit antennas.

Clause 24: The method of any one of Clauses 17-23, wherein the signaling to the UE indicating the one or more selected transmit antennas comprises a bitmap indicating the one or more selected antennas.

Clause 25: The method of any one of Clauses 17-24, further comprising periodically outputting signaling to the UE indicating one or more selected transmit antennas.

Clause 26: An apparatus, comprising: at least one memory comprising executable instructions; and at least one processor configured to execute the executable instructions and cause the apparatus to perform a method in accordance with any one of Clauses 1-25.

Clause 27: An apparatus, comprising means for performing a method in accordance with any one of Clauses 1-25.

Clause 28: A non-transitory computer-readable medium comprising executable instructions that, when executed by at least one processor of an apparatus, cause the apparatus to perform a method in accordance with any one of Clauses 1-25.

Clause 29: A computer program product embodied on a computer-readable storage medium comprising code for performing a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for receiving, means for performing, means for signaling, means for periodically receiving, means for obtaining, means for outputting, and means for periodically outputting may comprise one or more processors, such as one or more of the processors described above with reference to FIG. 13, and FIG. 14.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, the apparatus comprising:
a memory storing computer executable code; and
one or more processors coupled with the memory and configured to execute the computer executable code and cause the apparatus to:
receive signaling from a network entity indicating one or more selected transmit antennas;
receive a data transmission from the network entity; and
perform digital post distortion (DPOD) processing of the data transmission based on the one or more selected transmit antennas.

2. The apparatus of claim 1, wherein the one or more selected transmit antennas comprises a subset of transmit antennas at the network entity.

3. The apparatus of claim 1, wherein the one or more processors are further configured to cause the apparatus to signal a capability of the apparatus for performing DPOD based on antenna selection.

4. The apparatus of claim 3, wherein signaling the capability of the apparatus for performing DPOD based on antenna selection is via a physical uplink control channel (PUCCH).

5. The apparatus of claim 3, wherein signaling the capability of the apparatus for performing DPOD based on antenna selection is via a radio resource control (RRC) message.

6. The apparatus of claim 1, wherein the signaling from the network entity indicating the one or more selected transmit antennas comprises dynamic signaling of the one or more selected transmit antennas.

7. The apparatus of claim 6, wherein the dynamic signaling of the one or more selected transmit antennas is via a physical downlink control channel (PDCCH).

8. The apparatus of claim 1, wherein the signaling from the network entity indicating the one or more selected transmit antennas comprises one or more indexes of the one or more selected transmit antennas.

9. The apparatus of claim 1, wherein the signaling from the network entity indicating the one or more selected transmit antennas comprises a bitmap indicating the one or more selected antennas.

10. The apparatus of claim 1, wherein the one or more processors are further configured to cause the apparatus to periodically receive signaling from the network entity indicating one or more selected transmit antennas.

11. The apparatus of claim 1, wherein the one or more processors being configured to cause the apparatus to perform DPOD processing of the data transmission based on the one or more selected transmit antennas comprises the one or more processors being configured to cause the apparatus to:
estimate distortion added to the data transmission; and
remove the estimated distortion from the received data transmission.

12. The apparatus of claim 11, wherein the one or more processors being configured to cause the apparatus to estimate the distortion added to the data transmission comprises the one or more processors being configured to cause the apparatus to:
decode one or more demodulation reference signals (DMRS); and
determine precoding based on the one or more DMRS.

13. The apparatus of claim 11, wherein the one or more processors being configured to cause the apparatus to estimate the distortion added to the data transmission comprises the one or more processors being configured to cause the apparatus to perform Fast Fourier transform (FFT) and inverse FFT (IFFT) processing to generate a set of non-linearity kernels associated with the data transmission, and wherein a number of FFT operations and a number of IFFT operations is based on a number of the selected one or more transmit antennas.

14. The apparatus of claim 13, wherein the one or more processors being configured to cause the apparatus to estimate the distortion added to the data transmission comprises the one or more processors being configured to cause the apparatus to:
estimate a channel between the apparatus and the network entity; and
apply only subchannels, of the channel, associated with the selected one or more transmit antennas to the set of non-linearity kernels.

15. The apparatus of claim 14, wherein the subchannels comprise the subchannels between each receive antenna at the apparatus and each of the selected one or more transmit antennas of the network entity.

16. The apparatus of claim 14, wherein the one or more processors being configured to cause the apparatus to estimate the distortion added to the data transmission comprises the one or more processors being configured to cause the apparatus to estimate non-linearity coefficients of a power amplifier (PA) model of a PA at a transmitter of the data transmission, wherein a number of the non-linearity coefficients is based on a number of the selected one or more transmit antennas and a number of the set of non-linearity kernels.

17. An apparatus for wireless communication, the apparatus comprising:
a memory storing computer executable code; and
one or more processors coupled with the memory and configured to execute the computer executable code and cause the apparatus to:
obtain signaling from a user equipment (UE) of a capability of the UE for performing digital post distortion (DPOD) based on antenna selection;
output signaling to the UE indicating one or more selected transmit antennas of the apparatus; and
output a data transmission to the UE using the one or more selected transmit antennas.

18. The apparatus of claim 17, wherein the one or more selected transmit antennas comprises a subset of transmit antennas at the apparatus.

19. The apparatus of claim 17, wherein the one or more processors are configured to cause the apparatus to obtain the signaling from the UE of the capability of the UE for performing DPOD based on antenna selection via a physical uplink control channel (PUCCH).

20. The apparatus of claim 17, wherein the one or more processors are configured to cause the apparatus to obtain the signaling from the UE of the capability of the UE for performing DPOD based on antenna selection via a radio resource control (RRC) message.

21. The apparatus of claim 17, wherein the signaling to the UE indicating the one or more selected transmit antennas comprises dynamic signaling of the one or more selected transmit antennas.

22. The apparatus of claim 21, wherein the dynamic signaling of the one or more selected transmit antennas is via a physical downlink control channel (PDCCH).

23. The apparatus of claim 17, wherein the signaling to the UE indicating the one or more selected transmit antennas comprises one or more indexes of the one or more selected transmit antennas.

24. The apparatus of claim 17, wherein the signaling to the UE indicating the one or more selected transmit antennas comprises a bitmap indicating the one or more selected antennas.

25. The apparatus of claim 17, wherein the one or more processors are configured to cause the apparatus to periodically output signaling to the UE indicating one or more selected transmit antennas.

26. A method for wireless communication by a user equipment (UE), the method comprising:
receiving signaling from a network entity indicating one or more selected transmit antennas;
receiving a data transmission from the network entity; and
performing digital post distortion (DPOD) processing of the data transmission based on the one or more selected transmit antennas.

27. The method of claim 26, wherein the one or more selected transmit antennas comprises a subset of transmit antennas at the network entity.

28. The method of claim 26, further comprising signaling a capability of the UE for performing DPOD based on antenna selection.

29. The method of claim 28, wherein signaling the capability of the UE for performing DPOD based on antenna selection is via a physical uplink control channel (PUCCH).

30. A method for wireless communication by a network entity, the method comprising:
obtaining signaling from a user equipment (UE) of a capability of the UE for performing digital post distortion (DPOD) based on antenna selection;
outputting signaling to the UE indicating one or more selected transmit antennas of the network entity; and
outputting a data transmission to the UE using the one or more selected transmit antennas.
